(19) United States
(12) Patent Application Publication
(10) Pub. No.: US 2016/0096401 A1
(43) Pub. Date: Apr. 7, 2016

(54) PNEUMATIC VEHICLE TIRE

(71) Applicant: Continental Reifen Deutschland GmbH, Hannover (DE)

(72) Inventors: Lennert Gootjes, Wunstorf (DE); Ralf Krieger, Hannover (DE); Mario Pastuovic, Hildesheim (DE)

(21) Appl. No.: 14/970,053

(22) Filed: Dec. 15, 2015

Related U.S. Application Data
(63) Continuation of application No. PCT/EP2014/055894, filed on Mar. 25, 2014.

(30) Foreign Application Priority Data
Jun. 25, 2013 (DE) 10 2013 106 632.1

(51) Int. Cl. B60C 9/10; B60C 9/12; B60C 3/04

(52) U.S. Cl. CPC B60C 9/10; B60C 3/04; B60C 9/12

(57) ABSTRACT

A beltless pneumatic vehicle tire has a ratio of cross-sectional width to cross-sectional height of 1 or 0.85 determined in accordance with E.T.R.T.O standards and includes: a carcass of diagonal configuration including carcass inserts arranged one atop the other. Each carcass insert includes mutually parallel running reinforcement elements made of textile material and a rubber matrix wherein the reinforcement elements are embedded. The tire defines a tire zenith and a peripheral direction. The reinforcement elements of each two mutually adjacent ones of the carcass inserts are disposed relative to one another in a cross-bracing arrangement and run at respective equal acute angles (α, β) to the peripheral direction at the tire zenith. For a beltless pneumatic vehicle tire wherein the ratio is 1, the angle is between 28° and 34° and wherein the ratio is 0.85, the angle is between 26° and 32°.

### CROSS REFERENCE TO RELATED APPLICATIONS

This application is a continuation application of international patent application PCT/EP2014/055894, filed Mar. 25, 2014, designating the United States and claiming priority from German application 10 2013 106 632.1, filed Jun. 25, 2013, and the entire content of both applications is incorporated herein by reference.

### FIELD OF THE INVENTION

The invention relates to a beltless pneumatic vehicle tire having a ratio of cross-sectional width to cross-sectional height (determined according to European Tyre and Rim Technical Organization (E.T.R.T.O.) standards) of 1 or 0.85, with a carcass of a diagonal configuration comprising a number of carcass inserts arranged one over the other and having reinforcing elements of a textile material embedded in a rubber matrix and extending parallel to one another, the reinforcing elements in adjacently extending carcass inserts being arranged in relation to one another in a cross-bracing assembly and at the zenith of the tire extending in relation to the circumferential direction at an acute angle that is equal in all of the carcass inserts.

### BACKGROUND OF THE INVENTION

Although radial tires have become established in favor of cross-ply tires in many areas, in particular in the area of pneumatic tires for cars, cross-ply tires continue to be more appropriately used wherever the tires are subjected to high stresses, including overloading, or it is necessary for the vehicles that are fitted with these tires to be particularly stable. Cross-ply tires are therefore used for example on forklift trucks, vehicles that are used for handling containers, earth-moving machines, both underground and overground, trucks and the like. Depending on the intended use, cross-ply tires have one to three bead cores per bead region and between two and twenty six carcass inserts. In the case of cross-ply tires according to the prior art, it is customary that, in the ready-vulcanized tires, the reinforcing elements in the carcass inserts at the zenith of the tire form an angle with the circumferential direction of 20° to 45°, the size of the cord angle depending on the configuration of the tire with regard to its ratio of cross-sectional width to cross-sectional height, in order to give the tire a stable form. In the case of tires with a ratio of cross-sectional width to cross-sectional height (according to E.T.R.T.O. standards) of 1, angles of 36° to 45° are usual; in the case of tires with a ratio of cross-sectional width to cross-sectional height of 0.85, angles of 38° to 42°. This is so because the cord angle is usually chosen such that the tire increases in size uniformly when inflated with air as a result of the extension of the cord, so that the tire expands to a greater diameter and a greater width. This also depends on a uniform expansion of the rubber material in the tire.

The angle of the reinforcing elements in the inserts are set such that the tire is subjected to the lowest possible stresses when inflated with air. If the cross-ply tires are used on vehicles that are used for example in the area of underground mining, it is particularly important that the tires are as resistant to cutting as possible and have a high level of resistance to tearing. Therefore, special rubber blends are used for the region of the tire tread. However, specifically when these tires are used in the area of underground mining, the occurrence of cuts caused by rocks and rubble cannot be avoided. The stress-neutral configuration of the tire is conducive to an increase in the size of the tears with every revolution of the tire.

### SUMMARY OF THE INVENTION

It is an object of the invention to significantly improve the tear resistance of the tread of cross-ply tires.

The above object is achieved according to the invention by the angle that the reinforcing elements form with the circumferential direction at the zenith of the tire in the case of a tire with a ratio of cross-sectional width to cross-sectional height of 1 being between 28° and 34°, in the case of a tire with a ratio of cross-sectional width to cross-sectional height of 0.85 between 26° and 32°.

A cross-ply tire configured according to the invention is therefore no longer of a stress-neutral configuration. It therefore also has a behavior when inflating with air that differs from cross-ply tires of a stress-neutral configuration. The tire no longer increases in diameter, but has a somewhat greater widthwise increase than the cross-ply tires according to the prior art. Depending on the size of the angle of the reinforcing elements, a decrease in diameter may even occur. The carcass structure of cross-ply tires configured according to the invention is consequently stiffer in the circumferential direction than that in tires according to the prior art. This leads to a reduction in the rolling resistance, and consequently to reduced fuel consumption of the vehicles fitted with such tires. Since the tread rubber adhesively attached to the carcass is no longer extended in the circumferential direction, it is stiffer. This effect also results in a reduction in the rolling resistance. In addition, the stiffer tread is less susceptible to damage, for instance any damage caused by cutting is no longer spread but confined, with the effect of stopping or at least slowing down the propagation of a tear. In the case of a preferred embodiment of the invention, the angle that the reinforcing elements form with the circumferential direction in a tire with a ratio of cross-sectional width to cross-sectional height of 1 is at most 32°, in a tire with a ratio of cross-sectional width to cross-sectional height of 0.85 at most 30°. Such a configuration of the carcass inserts provided in the tire makes the tread particularly stiff and particularly resistant to damage caused by cutting and the like.

For the preferred intended use of these cross-ply tires as truck tires, industrial tires or OTR tires, in each case with the corresponding dimensions, it is advantageous for the stability of the tires and their durability if the number of carcass inserts is between six and twenty two, in particular between twelve and eighteen.

Two to four of these carcass inserts may be so-called breakers, that is, carcass inserts that extend radially within the tread and merely reinforce the region of the tread, and possibly the shoulder regions of the tire.

### BRIEF DESCRIPTION OF THE DRAWING

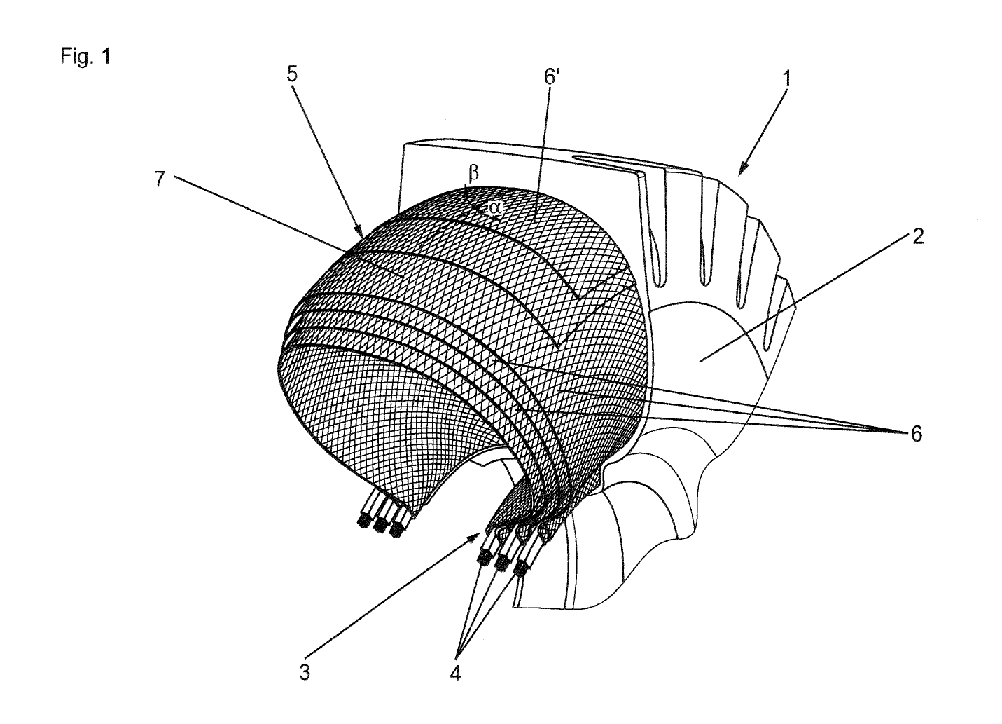

The invention will now be described with reference to the single figure of the drawing (FIG. 1) which schematically shows a view of a pneumatic vehicle tire according to the invention in a partially cut-open state, with the carcass exposed.

### DESCRIPTION OF THE PREFERRED EMBODIMENTS OF THE INVENTION

The invention relates to cross-ply tires, which are used in particular as truck tires, industrial tires and OTR tires on stony ground and poor roads or tracks and the ratio of cross-sectional width to cross-sectional height of which (determined according to E.T.R.T.O. standards) is 1 or 0.85.

FIG. 1 shows a beltless pneumatic vehicle tire of a diagonal configuration, which has a tread 1, sidewalls 2, bead regions 3 with bead cores 4 and a multi-ply carcass 5. The carcass 5 consists of a number of carcass inserts (6, 6′), the carcass inserts 6 extending radially outside an inner layer of a known configuration (not shown) over the circumference of the tire and in the axial direction between the bead cores 4 of the two bead regions 3 and also along and within the sidewalls 2 and the tread 1. In the case of the embodiment shown, each bead region 3 has three bead cores 4, which are made up in a known way of steel cords. In the case of the embodiment shown, also provided for each pair of bead cores are four carcass inserts 6, which are wound from the inside to the outside around the bead cores 4 concerned, so that the tire shown has sixteen carcass inserts 6. The carcass inserts 6 may end in a known way in the region of the bead cores 4. The carcass inserts 6′ are breakers, which do not extend from bead core 4 to bead core 4 but are provided in the tire extending radially within the tread 1 and in this way reinforce the tread region. Cross-ply tires configured according to the invention have one to three bead cores per bead region, and preferably between six and twenty two carcass inserts (6, 6′), in particular twelve to eighteen, of which two to four are breakers.

The carcass inserts (6, 6′) consist in each case of a cord fabric embedded in a rubber matrix and consisting of textile, parallel-extending reinforcing elements 7, which are for example cords of aramid, polyamide or polyester. Individual carcass inserts (6, 6′) are installed in the tire in such a way that the reinforcing elements 7 extend with left-hand and right-hand pitch alternately from insert (6, 6′) to insert (6, 6′), so that a stable ply assembly with crossing reinforcing elements 7 is formed.

At the zenith of the tire, and its interface with the equatorial plane of the tire, the reinforcing elements 7 in the ready-vulcanized tire form an angle α or β with the circumferential direction of the tire, the angles (α, β) being equal. In the case of a tire with a ratio of cross-sectional width to cross-sectional height of 1, the angles (α, β) are between 28° and 34°, in particular up to 32°; in the case of a tire with a ratio of cross-sectional width to cross-sectional height of 0.85, between 26° and 32°, in particular up to 30°. In all of the carcass inserts (6, 6′) of a specific tire, the angles (α, β) of the reinforcing elements 7 are equal, while deviations due to production tolerances of 2° to at most 3° are possible.

The angle that the reinforcing elements 7 in the carcass inserts (6, 6′) at the zenith of the tire form with the circumferential direction is therefore less than the angle of the reinforcing elements in conventional tires with a ratio of cross-sectional width to cross-sectional height of 1 or 0.85. As a result, the behavior of the tire when inflating with air changes; no increase in diameter of the tire in the region of the tread takes place, but instead a greater increase in the width of the tire. As a result of the relatively small angle of the reinforcing elements 7 in relation to the circumferential direction, the carcass structure in the circumferential direction in the case of cross-ply tires configured according to the invention is stiffer than in the case of those from the prior art. If the angle of the reinforcing elements 7 is chosen such that the above values are obtained in the finished tire, a compression of the tread rubber in the circumferential direction even takes place when the tire is inflated with air, whereby the tread becomes stiff. The greater stiffness of the carcass and of the tread in the circumferential direction reduces the rolling resistance of tires according to the invention, and consequently the fuel consumption of vehicles with such tires. Since the tread rubber adhesively attached to the carcass is no longer extended in the circumferential direction, but if anything is even compressed, it is less susceptible to damage caused by cutting. Any cut occurring is not spread but confined. In instances of damage caused by cutting, propagation of a tear is therefore stopped or slowed down.

It is understood that the foregoing description is that of the preferred embodiments of the invention and that various changes and modifications may be made thereto without departing from the spirit and scope of the invention as defined in the appended claims.

### LIST OF DESIGNATIONS

1 . . . tread
2 . . . sidewall
3 . . . bead region
4 . . . bead core
5 . . . carcass
6, 6′ . . . carcass insert
7 . . . reinforcing element
α, β . . . angle

What is claimed is:

1. A beltless pneumatic vehicle tire has a ratio of cross-sectional width to cross-sectional height of 1 or 0.85 determined in accordance with E.T.R.T.O standards and comprises:
a carcass of diagonal configuration including a plurality of carcass inserts arranged one atop the other;
each of said carcass inserts including a plurality of mutually parallel running reinforcement elements made of textile material and a rubber matrix wherein said reinforcement elements are embedded;
said beltless pneumatic vehicle tire defining a tire zenith and a peripheral direction;
the reinforcement elements of each two mutually adjacent ones of said carcass inserts being disposed relative to one another in a cross-bracing arrangement and running at respective equal acute angles (α, β) to said peripheral direction at said tire zenith; and,
(a) for a beltless pneumatic vehicle tire wherein said ratio is 1, said angle is between 28° and 34°; and,
(b) for a beltless pneumatic vehicle tire wherein said ratio is 0.85, said angle is between 26° and 32°.

2. The beltless pneumatic vehicle tire of claim 1, wherein said angle (α, β) is at most 32° when said ratio is 1.

3. The beltless pneumatic vehicle tire of claim 1, wherein said angle (α, β) is at most 30° when said ratio is 0.85.

4. The beltless pneumatic vehicle tire of claim 1, wherein the number of said carcass inserts lies between six and twenty-two.

5. The beltless pneumatic vehicle tire of claim 1, wherein the number of said carcass inserts lies between twelve and eighteen.

6. The beltless pneumatic vehicle tire of claim 1, wherein two to four of said carcass inserts are breakers.
